(19) United States
(12) Patent Application Publication
(10) Pub. No.: US 2009/0280747 A1
(43) Pub. Date: Nov. 12, 2009

(54) Method and Apparatus for Interference Cancellation in a Wireless Communication System

(75) Inventors: Pallav Sudarshan, Waukegan, IL (US); Kenneth A. Stewart, Grayslake, IL (US); Xiangyang Zhuang, Lake Zurich, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/116,582

(22) Filed: May 7, 2008

(51) Int. Cl. H04B 15/00; H04B 1/06

(52) U.S. Cl. 455/63.1; 375/346

(57) ABSTRACT

A mobile device estimates a data symbol from a received signal by using one or more interference cancellation algorithms. For one interference cancellation algorithm, the mobile device calculates a correction factor by estimating a Doppler speed and a time difference between a first time interval like a preamble symbol and a second time interval like any symbol of interest in an assigned data allocation in the data zone. Using the correction factor, the mobile device updates outdated interference information. The mobile device cancels interference in the received signal distorted by co-channel interference by using the updated interference information. Also, the mobile device is configured to combine results of multiple interference cancellation algorithms based on the applicability of the individual interference cancellation algorithms in particular scenarios.

### FIELD OF THE DISCLOSURE

The present disclosure relates generally to wireless communications and more particularly to a method and apparatus for cancelling interference from a received signal in a wireless communication system.

### BACKGROUND

In a wireless communication system, a mobile device establishes a radio link with at least one base station to communicate with another communication device. A cellular communications system is a typical example of such wireless communication systems. A cellular communications system includes several base stations, such that each base station provides radio coverage to a sub-portion of the service area, which constitutes a cell. Generally, a cell is divided into sectors. However, in this document the terms ‘radio cell,’ ‘cell,’ ‘radio coverage region,’ and ‘sector’ are used interchangeably. In one deployment scenario, each sector is allocated a portion of the total number of frequency channels available to the entire system such that neighboring sectors are assigned different frequency channels. The neighboring sectors are assigned different channels so that interference between nearby sectors operating on the same channels is minimized. This deployment scenario is often referred as “reuse>1.” Here, a frequency channel is referred to as the nominal bandwidth used by one or more communication links between a base station and a mobile device. A frequency channel can further consist of multiple subcarriers in the example of OFDM (Orthogonal Frequency Division Multiplexing) technology.

In another deployment scenario called ‘reuse-1’, all sectors share a single frequency channel. As a special case of this scenario, in order to create a “virtual reuse>1” deployment, all the OFDM subcarriers may be divided into groups (or sub-bands) which are assigned for sectors so that neighboring sectors get assigned different sub-bands.

In a typical cellular communications system, there will be several radio sectors, either neighboring to or apart from each other, that will inevitably occupy the same frequencies (channels). Such radio sectors are called co-channel sectors. The interference between signals from the co-channel sectors/cells is called co-channel interference. To reduce co-channel interference, co-channel sectors/cells are best physically separated by a minimum distance to provide sufficient isolation due to propagation of signals from neighboring co-channel sectors/cells. However, it is not always possible, for example in the “reuse-1” scenario where all neighbor sectors/cells become interference sources to each other.

Co-channel interference affects the reception of downlink traffic sent from a base station to a mobile device. For example, co-channel interference affects the downlink control messages. Due to co-channel interference, bits in the downlink control messages may get garbled. Typically, a mobile device establishes a radio link with a base station by following instruction and allocations conveyed in the downlink control messages. Thus, the actual radio coverage region of a base station depends on the capability of a mobile device to accurately receive downlink control messages at a distance away from the base station. Because a mobile device cannot establish a radio link with the base station if the downlink control message is corrupted due to co-channel interference, this can result in substantially smaller radio coverage regions associated with each base station. Unlike thermal noise, co-channel interference cannot be combated by increasing the carrier power of the transmitter at the base station because an increase in the carrier power by all the base stations would result in increased co-channel interference in the neighboring co-channel sectors/cells. Conventionally the radio coverage of the downlink control messages is increased by using very low rate coding or repetition coding. However, the use of repetition/low rate coding results in high overhead in signaling.

Accordingly, there is a need for a method and an apparatus to cancel interference in the received signal at a receiver in a wireless communication system which addresses at least some of the shortcomings of past and present techniques for processing a received signal at a receiver in a wireless communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a cellular communications system where embodiments of the invention can be implemented.

FIG. 2 illustrates a sequence of signals received at a receiver in a wireless communication system.

FIG. 3 is a flowchart of a method of cancelling interference from a sequence of received signals in accordance with a first embodiment.

FIG. 4 is a flowchart of a method of cancelling interference from a sequence of received signals in accordance with a second embodiment.

FIG. 5 is a flowchart of a method of cancelling interference from a sequence of received signals in accordance with a third embodiment.

FIG. 6 illustrates simulation results obtained from implementing some embodiments of the invention.

FIG. 7 is a block diagram illustrating portions of a mobile device which is configured for cancelling interference in a sequence of received signals in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments, a mobile device estimates data symbols from a received signal by using an interference cancellation algorithm. The mobile device receives a sequence of signals from a base station of a serving sector (i.e., a sector that transmits “desired” data symbols). As used herein, ‘a sequence of signals’ refers to a plurality of signals received by the mobile device at different time intervals. One example of a sequence of signals is a series of OFDM symbols each of which occupies a time interval and in the frequency domain consists of a plurality of OFDM subcarriers.

The received signal in totality is a signal from the serving base station through a multi-path propagation channel and signals from interfering sectors. In a narrow-band system, the effect of a channel can be modeled mathematically by a single complex-valued scalar. The scaling representation is also valid for OFDM systems on each subcarrier. In the case of the OFDM system, mathematically, the received signal can be represented as

$$y = hs + {\sum }_{k = 1}^{K} {h}_{k} {s}_{k} + n$$

where y is the received signal, h is the scaling factor of the serving base station, is the signal from the serving base station, hₖ is the scaling factor from the k^{th} interfering sector, sₖ is the signal from the k^{th} interfering sector, and n is the noise at the mobile device.

The scaling of the signal from a base station is referred to as the channel state, and the knowledge of the channel at the mobile device is referred to as Channel State Information (CSI).

The mobile device calculates the CSI of at least one interfering sector from a signal received at a first time interval. In one embodiment, the received signal at the first time interval can be a signal that facilitates a good CSI estimation for at least one interfering sector. In another embodiment, the received signal at the first time interval can be a specially-designed pilot signal for enabling mobile devices to perform certain system functions, including facilitating better CSI estimation to at least the serving sector, and sometimes also to the neighboring sectors that cause co-channel interference in other types of data transmission. An example of such a special signal is a “preamble” as referred to in the Institute of Electrical and Electronics Engineers (IEEE) 802.16 standards.

The mobile device also calculates a CSI of the serving sector corresponding to a second time interval. In one embodiment, the mobile device uses the pilots at the second time interval to obtain this CSI of the serving sector. In another embodiment, the mobile device can use the received signal at the first time interval (e.g., during a preamble) for calculating the CSI of the serving sector. In yet another embodiment, the mobile device can use both the pilots and the preamble to estimate the CSI of the serving sector corresponding to the second time interval.

The mobile device determines an estimate of the CSI of at least one interfering sector at the second time interval. In one embodiment, the mobile device uses the CSI estimate at the first time interval along with a correction factor to estimate the CSI at the second time interval. In another embodiment, the mobile device determines the estimate of the CSI of at least one interfering sector at the second time interval using a combination of the CSI at the first time interval, the correction factor, and the second received signal. In yet another embodiment, the mobile device determines the estimate of the CSI of at least one interfering sector at the second time interval using the second received signal.

The correction factor to the CSI of the at least one interfering base station is to account for the “aging” of the CSI learned at the first time interval. It is based on at least the elapsed time between the first and second time intervals. In one embodiment, the correction factor is also based on measure of a relative speed of the mobile device with respect to the serving sector (e.g., Doppler frequency). In another embodiment, the correction factor is determined using a look-up-table.

In a particular system defined according to IEEE 802.16 standards, one example of the look-up-table to determine the correction factor α is

$$α = \{ \begin{matrix}0.98 & v < 20 \text{kmph} \\ A ( j ) & v > 20 \text{kmph}\end{matrix}$$

where v is an estimate of a relative speed of the mobile device with respect to the serving sector, j is the elapsed time between the first and second time interval (in terms of OFDMA symbol durations), and A(j) is a set of pre-determined values given by

A=[0.9942 0.9770 0.9486 0.9096 0.8606 0.8025 0.7362 0.6629 0.5838 0.5003].

In order to cancel the interference in the received signal at the second time interval to recover the desired data symbol, the mobile device applies ‘receive weights’ (i.e., a filter with coefficients each applied on the signal from each receive antenna of the mobile device). The recovered desired data symbol ŝ can be represented as

ŝ=w^{H}y

where w is the ‘receive weights’ and y is the received signal at the second time interval.

The mobile device computes the interference cancellation ‘receive weights’ based on the CSI of the serving sector at the second time interval and the estimate of the CSI of the at least one interfering sector at the second time interval. The mobile device then applies the ‘receive weights’ to the received signal at the second interval to obtain an estimate of the transmitted data symbol from the serving sector, as illustrated above. In one embodiment, the estimate of the CSI of the at least one interfering sector at the second time interval can be obtained from the CSI of the at least one interfering sector at the first time interval and the correction factor.

The estimated data symbol is generally an accurate estimation of the actual data symbol transmitted from the sector of the serving cell. If the interfering sector is interfering through co-channel interference, more accurate data symbol estimates can allow for larger effective radio coverage regions associated with each base station. Also, accurate reception of data symbols helps to reduce the signaling overhead in signals transmitted from the sector of the serving cell.

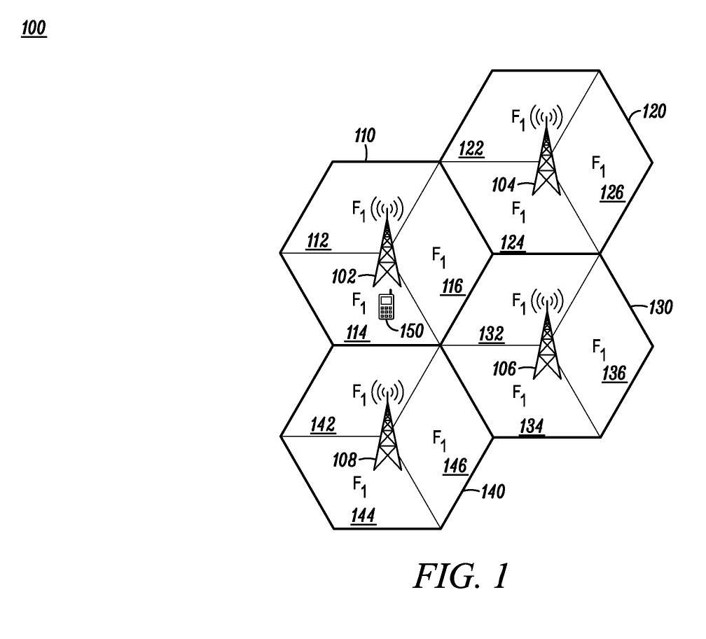

Referring now to the drawings, and in particular FIG. 1, a cellular communications system 100 can be used to implement a method to cancel interference in a received signal at a receiver apparatus in accordance with some embodiments. Those skilled in the art will recognize and appreciate that the specifics of this example are merely illustrative of some embodiments and that the teachings set forth herein are applicable in a variety of alternate settings. For example, in some embodiments, the mobile device and a base station operate in accordance with standards promulgated by the Institute of Electrical and Electronics Engineers (IEEE), such as IEEE standard 802.16(e) which relates to mobile Worldwide Interoperability for Microwave Access (WiMAX). However, the teachings disclosed herein are in no way limited to this system implementation. As such, other alternate implementations using different communications systems operating on different protocols are contemplated and are within the scope of the various teachings described herein.

The cellular communications system 100 shown has four base stations 102, 104, 106, 108. As used herein, the ‘term base station’ includes, but is not limited to, equipment commonly referred to as base transceiver stations, site controllers, access points, or any other type of interfacing device in a wireless environment. Each base station has at least a transceiver apparatus (i.e., a transmitter and receiver), a processing device, and an interface for communication with a base station controller (not shown), wherein the interface may be a fixed-line interface or a wireless interface established using any suitable protocol. The base station controller (not shown) at least logically has a processor for handling transmission and reception, error handling, radio resource allocation such as admission control and channel allocation, signal power control, handover control, etc. The base station and the base station controller may further include memory elements and other interfaces.

Each of the base stations 102, 104, 106, 108 has an associated radio coverage region (or cell). For example, as shown in FIG. 1, the four base stations 102, 104, 106, 108 have four radio coverage regions (or cells) 110, 120, 130, 140 associated with them respectively. A radio coverage region (or cell) is roughly an area in which signal strength of radio signals from the associated base station is above certain threshold.

Generally, a radio coverage region is divided into sectors. For example, as shown in FIG. 1, the radio coverage region (or cell) 110 is divided into three sectors 112, 114, 116. Similarly, as shown in FIG. 1, other the radio coverage regions (or cells) 120, 130, 140 are divided into three different sectors. However, in this document the terms ‘radio cell,’ ‘cell,’ ‘radio coverage region,’ and ‘sector’ are used interchangeably. Generally, for every sector there is a different set of antennas that communicates with mobile devices in that particular sector. As shown in FIG. 1, all the sector antennas (not shown) for sectors 112, 114, 116, 122, 124, 126, 132, 134, 136, 142, 144, 146 communicate with a plurality of mobile devices (not shown) using the same frequency band F₁. In one embodiment, all sector antennas are co-located at the base station site.

Generally, in a cellular communications system, the total available frequency channels are divided into groups of channels. These groups of channels are allocated to different radio coverage regions (or cells/sectors) such that the total capacity of the cellular communications system is enhanced. The design process of intelligently allocating the channels (or frequencies) to increase the overall capacity is called the process of frequency reuse. A frequency reuse process is characterized by a frequency reuse factor. The frequency reuse factor is the rate at which the same frequency can be used in the cellular communications system. The frequency reuse factor is defined as 1/K where K is the number of cells which cannot use the same frequencies for transmission. Common values for the frequency reuse factor are 1/1, 1/3, 1/4, 1/7, 1/9, and 1/12 (or 1, 3, 4, 7, 9, and 12 depending on notation).

As shown in FIG. 1, the base station 102 communicates on frequency F₁ with a plurality of mobile devices (not shown) in all sectors 112, 114, 116 of the radio coverage region 110. Similarly, other base stations 104, 106, 108 communicate using the same frequency F₁ in all sectors of their respective radio coverage regions (or cells) 120, 130, 140. Thus, the frequency reuse factor for the cellular communications system 100 shown in FIG. 1 is unity. In this ‘reuse 1’ scenario, adjacent sectors can act as sources for co-channel interference. Those skilled in the art will recognize and appreciate that the specifics of the cellular communications system 100 shown in FIG. 1 is merely illustrative of some embodiments and that the teachings set forth herein are applicable to a variety of alternate settings. For example, in accordance with some embodiments, a method to cancel interference in a received signal can be implemented in a cellular communications system having a frequency reuse factor of 3. In a frequency reuse factor of 3, the frequency F₁ could be augmented with two non-overlapping frequency bands F₂, F₃, and each sector of a cell is assigned a different frequency band. In this way, the same frequency F₁ is no longer being used in adjacent sectors. Thus, the teachings disclosed herein are equally applicable to all cellular communications systems irrespective of the particular frequency reuse factor used.

FIG. 1 also shows a mobile device 150 communicating with the base station 102. As used herein, the term ‘mobile device’ includes, but is not limited to, equipment commonly referred to as access devices, access terminals, user equipment, mobile stations, mobile subscriber units, and any other terminal device capable of operating in a wireless environment. The mobile device 150 has at least transceiver apparatus (i.e., a transmitter and receiver), a processing device, and an interface for communication with an access point or another mobile device (not shown), wherein the interface may be established using any suitable protocol. The mobile device 150 may further include a user interface, a portable power source, and a memory device for carrying out its functionality. Those skilled in the art will recognize and appreciate that each mobile device may be, but is not limited to, one of the following communication devices: cellular telephones, wireless personal data assistants, mobile computers, and the like.

In the cellular communications system 100, the base station 102 transmits radio signals at frequency F₁ to communicate with the mobile device 150. As shown in FIG. 1, the other base stations 104, 106, 108 are also using the same frequency F₁ to communicate with mobile devices (not shown) in radio coverage regions 120, 130, 140 respectively. Thus, the signals from the neighboring sectors interfere with the signals from the serving base station 102, and the mobile device 150 receives a signal corrupted by co-channel interference. The mobile device 150 is configured to estimate data symbols from the corrupted signal received from the base station 102 by using an interference cancellation algorithm in accordance with some embodiments.

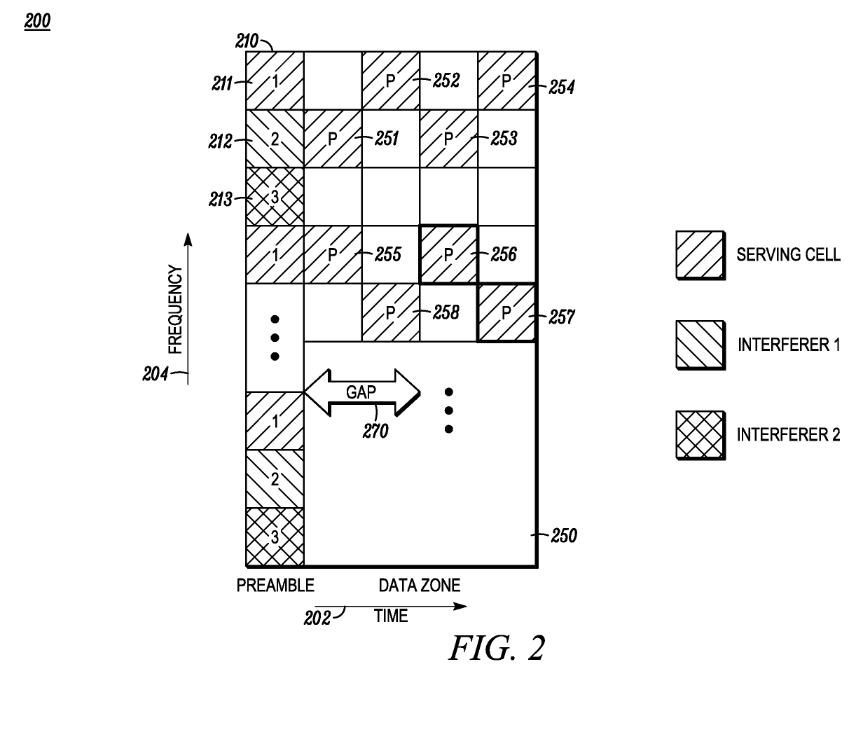

FIG. 2 illustrates a sequence of signals 200 received at a receiver in an OFDM wireless communication system. The receiver may be implemented as the receiver in the mobile device 150 shown in FIG. 1. The serving base station would be the base station 102, and the other base stations 104, 106, 108 using the same frequency channel F₁ would be interfering base stations. Radio signals from neighboring sectors can result in co-channel interference. As shown in FIG. 2, the sequence of received signals 200 has a preamble signal 210 and data signals distributed in time 202 and frequency 204. A plurality of OFDM symbols constitutes a data zone 250 and any particular mobile device can be assigned a portion of the data zone 250.

As shown in FIG. 2, the preamble signal 210 includes a plurality of preamble pilot symbols. The preamble pilots typically can be used to estimate the propagation channel from a serving base station and/or interfering base station(s). For example, the preamble pilots denoted as “1” starting from 211 are transmitted from the serving base station, and another set of preamble pilots denoted as “2” starting from 212 are transmitted from a first interfering base station. Similarly, the set of preamble pilots denoted as “3” starting from 213 are transmitted from a second interfering base station.

The data symbols in the data zone 250 typically include a plurality of pilots 251, 252, 253, 254, 255, 256, 257, 258 which can be used to estimate a channel of a serving base station. As used herein, a serving base station is a base station which enables a mobile device with the receiver to communicate with other mobile/fixed-line communication devices. A portion of the data zone 250 can be assigned to a user where the assigned data allocation contains a set of pilots. As an example, an assigned data allocation can contain pilots 256 and 257. Generally, there is a time gap 270 between the preamble symbols and the assigned data allocation in the data zone 250.

### Preamble-Based Interference Cancellation Algorithm

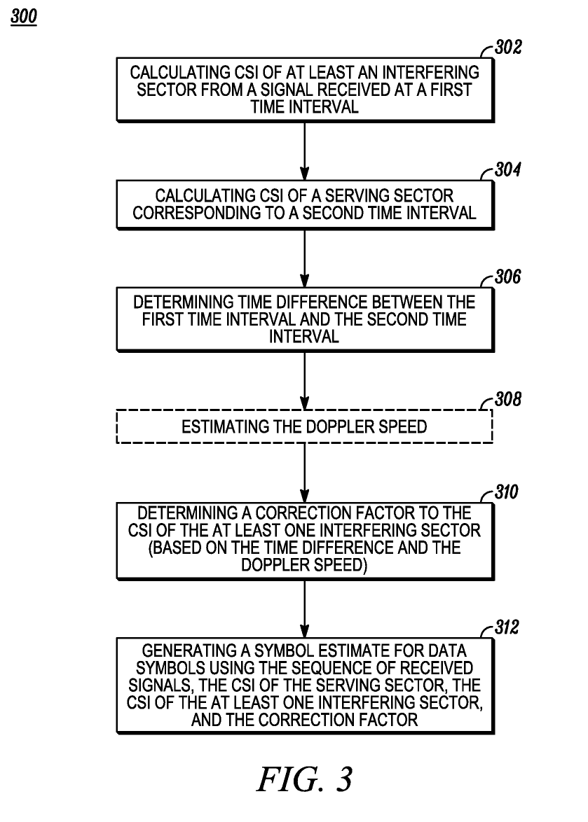

Turning now to FIG. 3, a flow diagram 300 illustrates a method of cancelling interference from a sequence of received signals in accordance with a first embodiment. In this embodiment, the flow diagram 300 is implemented at a mobile device such as mobile device 150 (FIG. 1) which receives a sequence of signals corrupted by co-channel interference from non-serving base stations 104, 106, 108, wherein the received signal has a plurality of symbols.

At step 302, the mobile device calculates a Channel State Information (CSI) of at least an interfering sector from a signal received at a first time interval. In one embodiment, a signal received at a first time interval can be the preamble and the mobile device calculates the CSI of an interfering sector from the preamble signal 210 in the sequence of received signals. The CSI of the interfering sector has information related to a channel of an interfering base station that interferes with signals transmitted from the serving sector at the first time interval. As shown in FIG. 2, the preamble signal contains symbols 212, 213 that contain information about channels used by interfering sectors. The mobile device can then use the pilots in the preamble signal 210 to determine the CSI of at least one interfering sector.

At step 304, the mobile device calculates a CSI of a serving sector corresponding to a second time interval. As an example, a second time interval can be any symbol within the assigned data allocation in a data zone. In one embodiment the mobile device calculates the CSI of a serving sector corresponding to a second time interval from a preamble symbol 211 (FIG. 2) in the sequence of received signals and also from the pilots embedded in the signals at the assigned data allocation (e.g., 256 and 257). At step 306, the mobile device processes the sequence of received signals to determine a time difference between the first time interval and the second time interval. In one example, when the first time interval is during the preamble 210, the time difference can be equated to the time gap 270 between the preamble signal 210 and the assigned data allocation in the data zone 250.

At optional step 308, the mobile device estimates its Doppler speed. The Doppler speed is defined as a relative speed of the mobile device with respect to a base station of the serving sector. For example, if the mobile device 150 (FIG. 1) is stationary with respect to its serving base station 102, the Doppler speed is zero. At step 310, the mobile device determines a correction factor, wherein the correction factor depends on the time difference and optionally, the estimated value of the relative speed of the mobile device with respect to a base station of the serving cell (i.e., Doppler speed). In an alternate embodiment, the mobile device stores a pre-determined lookup table which includes correction factors that correspond to particular pairs of time difference and Doppler speed. Based on the Doppler speed and the time difference, the mobile device selects a correction factor from the predetermined table.

Typically, the mobile device applies the correction factor to update the CSI of at least one interfering sector. Generally, the CSI of at least one interfering sector changes with time. Due to a time gap (time difference) between the preamble symbol and the assigned data allocation in the data zone, the CSI of at least one interfering sector determined at step 302 gets outdated by the time the mobile device is ready to process the signal at the assigned data allocation to estimate the data symbols. Generally, to update the CSI of an interfering sector for the purpose of interference cancellation, the mobile device weights the outdated CSI of the interfering cell with the correction factor.

The correction factor can be determined based on the Doppler and the time difference between a first and a second time interval (i.e., between preamble and any symbol within the assigned data allocation in a data zone in the above example). In one embodiment, one can model the channel of the at least one interfering cell using a first-order regression model. For example, a channel hₖ of the k^{th} interfering sector at a second time interval can be modeled in terms of the channel hₚₖ at the first time interval (e.g., preamble) using the first-order regression model:

hₖ=αₖhₚₖ+σₖnₚₖ (1)

Here αₖ is the linear scaling factor (correction factor), σₖ is an error variance and nₚₖ is the error term that attributes to the mismatch between the channel as predicted by the linear scaling αₖhₚₖ and the true channel at a second time interval due to relative motion between the mobile device and the base station (i.e., Doppler effect). Typically, the error term σₖnₚₖ is assumed to be independent of the channel of the interfering base station at a first time interval.

The value of the correction factor can be estimated by assuming Jakes correlation model such that

E[hₖhₖₚ*]=J₀(2πf_{d}τ) (2)

Here τ is the time difference (e.g., in seconds) between the preamble and one symbol within the assigned data allocation, and f_{d} is the Doppler frequency. In one embodiment, the correction factor, αₖ can be determined as

αₖ=J₀(2πf_{d}τ) (3)

Furthermore, it is reasonable to assume that the mean channel power at the first and second time interval is unchanged, i.e., E[|hₚₖ|²=E|hₖ|²], which implies

$${σ}_{k} = \sqrt{( 1 - {α}_{k}^{2} ) E [ {\vert {h}_{p k} \vert}^{2} ]} \qquad ( 4 )$$

The value of E[|hₚₖ|²] can be estimated by averaging the power of an interferer's channel as estimated from the preamble.

At step 312, the mobile device generates a symbol estimate for data symbols based on the sequence of received signals, the CSI of the serving sector, the CSI of at least one interfering sector, and the correction factor. Typically, as described above the mobile device calculates an updated CSI of at least one sector using the CSI at the first time interval and the correction factor.

In one embodiment, generating a data symbol estimate by using the CSI of the serving sector and the updated CSI of at least one interfering sector further entails computing interference cancellation antenna weights based on the CSI of the serving sector and the updated CSI of at least one interfering sector, and applying the interference cancellation antenna weights to a sequence of received signals to obtain estimates of transmitted data symbols. The interference cancellation antenna weights are applied on each receive antenna at the second time interval.

For example, interference cancellation antenna weights “w” (a vector of weights) can be obtained from hₚₖ (a vector of channels from each of the receive antennas to the k^{th} interfering sector at a first time interval) and h (a vector of channels from each of the receive antennas to a serving cell also at a second interval) such that

$$w = \frac{{( {\sum }_{k} {α}_{k}^{2} {h}_{p k} {h}_{p k}^{H} + ( {σ}_{0}^{2} + {\sum }_{k} {σ}_{kp}^{2} ) I )}^{- 1} h}{{{h}^{H} ( {\sum }_{k} {α}_{k}^{2} {h}_{k} {h}_{k}^{H} + ( {σ}_{0}^{2} + {\sum }_{k} {σ}_{kp}^{2} ) I )}^{- 1} h} \qquad ( 5 )$$

Here, the superscript “H” denotes the Hermitian operation of a vector or matrix, σ₀² is the thermal noise variance and σₖₚ² accounts for the error term due to CSI mismatch between the channel as predicted by the linear scaling αₖhₚₖ and the true channel at a second time interval.

Additionally, σₖₚ² can also include the CSI estimation error for the serving base station and the contribution of all other interfering sectors which are targeted for cancellation at the mobile device. The interference cancellation antenna weights w are applied to the received signal to obtain data symbol estimates. The error variance of data symbol estimates can be obtained as

$${σ}^{2} = \frac{1}{{{h}^{H} ( {\sum }_{k} {α}_{k}^{2} {h}_{k} {h}_{k}^{H} + ( {σ}_{0}^{2} + {\sum }_{k} {σ}_{kp}^{2} ) I )}^{- 1} h} \qquad ( 6 )$$

In an alternate embodiment, computing the interference cancellation antenna weights involves calculating a channel covariance matrix of the at least one interfering sector based on the corresponding CSI at a first time interval. The channel covariance matrix is then weighed by the correction factor to calculate a weighted channel covariance matrix. Finally, the interference cancellation weights can be determined based on the weighed channel covariance matrix and the CSI of the serving sector.

Because the interference cancellation algorithm described above is based on the information derived from a preamble in the sequence of received signals, the above-described interference cancellation algorithm is referred to as a Preamble-Based Interference Cancellation Algorithm. This Preamble-Based Interference Cancellation Algorithm is highly effective in cancelling co-channel interference in low Doppler scenarios. However, in high Doppler scenarios, or when the time gap between the preamble and the symbol of interest (i.e., a second time interval) is large (a large value of τ), the correction factor as defined in equation (3) approaches zero (i.e., αₖ→0). Thus, this Preamble-Based Interference Algorithm may not be very effective in cancelling co-channel interference in high Doppler scenarios.

### Pilot-Based Interference Cancellation Algorithm

Preamble-based Interference Cancellation Algorithm generates a first estimate of data symbols. The mobile device can also compute a second data symbol estimate for the same transmitted symbols using the pilot information embedded in the signal at the assigned data allocation in the data zone 250 of the received signal. See FIG. 2. In one embodiment, the mobile device identifies a set of pilot locations over which the CSI of the serving sector and the CSI of the at least one interfering sector can be assumed to be invariant. The mobile device obtains a pilot estimate by multiplying the received signals at a set of pilot locations and a vector of combining weights. Based on the pilot estimate, the mobile device calculates an error variance. Typically, the estimate of error variance of the pilot estimates is defined as

$${\hat{σ}}^{2} = \frac{1}{N} {p}^{H} ( p - Yw ) \qquad ( 7 )$$

Here p=[p(0), p(1), . . . , p(N−1)]^{T} is the serving sector's pilot sequence at a set of pilot locations and w is Minimum Mean Squared Error (MMSE) combining weights as well known in prior arts for estimating the pilots.

The estimate of error variance on the data symbols is obtained by suitably scaling this value according to the pilot-to-data power ratio. Using the noise variance of the data symbol, the mobile device generates a second data symbol estimate. Because this interference cancellation algorithm is based only on the information derived from the pilots embedded in the data zone of the sequence received signals, the above described interference cancellation algorithm is referred to as a Pilot-Based Interference Cancellation Algorithm.

### Hybrid Interference Cancellation Algorithm

As described above the Preamble-Based Interference Cancellation Algorithm is expected to give good performance in low Doppler scenarios, and when the time difference between the data symbol of interest and the preamble is small. On the other hand, the performance of Pilot-Based Interference Cancellation Algorithm is more robust because it uses the pilots embedded in the assigned data allocation. However, the mobile device needs to assume that the CSI of the serving sector and the CSI of the at least one interfering sector is invariant over the set of pilots within a time-frequency region. Hence the performance of Pilot-Based Interference Cancellation Algorithm depends on the frequency-selectivity of the channel with that time-frequency region, and on the number of pilots available for determining the interference cancellation weights. Because these two methods perform well under different conditions and, in general, give two different estimates of the same transmitted data symbols, it is of interest to derive a unified interference design that combines these two methods. The unified interference cancellation algorithm is referred to as a Hybrid Interference Cancellation Algorithm.

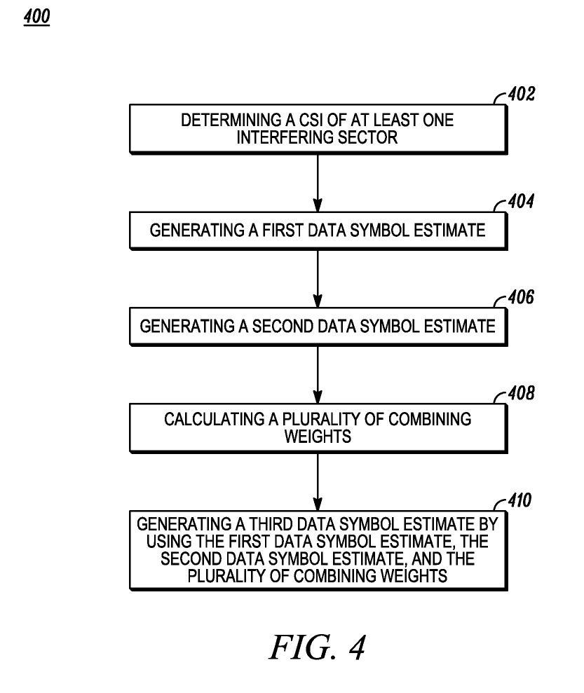

Turning to FIG. 4, a flow diagram 400 illustrates a method of cancelling interference from a sequence of received signals in accordance with a second embodiment. In this embodiment, the flow diagram 400 is implemented at a mobile device such as mobile device 150 (FIG. 1) which receives a signal corrupted by co-channel interference, wherein the received signal has a plurality of symbols.

At step 402, the mobile device determines a CSI of at least one interfering sector. At step 404, the mobile device generates a first data symbol estimate. In one embodiment, the mobile device generates the first data symbol estimate by using a preamble symbol (FIG. 2) in the received signal. Typically, the mobile device uses a Preamble-Based Interference Cancellation Algorithm to generate this first data symbol estimate. However, in alternate embodiments the mobile device can extract data from any signal received at a time interval amongst the sequence of received signals to generate the first data symbol estimate.

At step 406, the mobile device generates a second data symbol estimate. In one embodiment, the mobile device generates the second data symbol estimate by using pilot information embedded in the data zone 250 (FIG. 2) of the received signal. Typically, the mobile device uses a Pilot-Based Interference Cancellation Algorithm to generate the second data symbol estimate. However, in alternate embodiments the mobile device can extract data from any signal received during the time interval to generate the second data symbol estimate. At step 408, the mobile device calculates a plurality of combining weights. In one embodiment, the plurality of combining weights is calculated using the error variance values obtained from the Preamble-Based Interference Cancellation Algorithm and the Pilot-Based Interference Cancellation Algorithm.

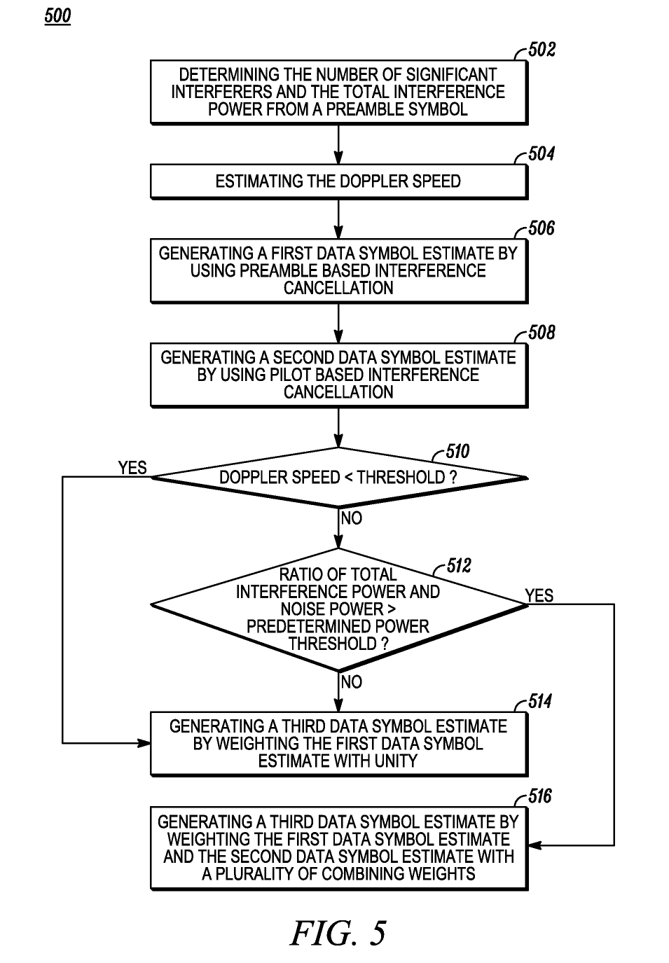

At step 410, the mobile device generates a third data symbol estimate by using the first data symbol estimate, the second data symbol estimate, and the plurality of combining weights. Since the third data symbol estimate is obtained using information derived from a Preamble-Based Interference Cancellation Algorithm and a Pilot-Based Interference Cancellation Algorithm, the above described interference cancellation algorithm is referred as a Hybrid Interference Cancellation Algorithm. Illustrative details of generating the third data symbol estimate will next be described with reference to FIG. 5.

FIG. 5 shows a flow diagram 500 of a method for cancelling interference from a sequence of received signals in accordance with a third embodiment. This embodiment is a more detailed version of the flow diagram shown FIG. 4. Like FIG. 4, the flow diagram 500 is implemented at a mobile device which receives a signal corrupted by co-channel interference, wherein the received signal has a plurality of symbols.

At step 502, the mobile device determines the number of significant interferers and the total interference power due to the significant interferers. In one embodiment, an interfering sector is considered as a significant interferer if the ratio of the interference power due to that interferer sector relative to the thermal noise exceeds a predetermined threshold. In another embodiment, a fixed number of interfering sectors (e.g., two top ones) are always counted as significant interferers based on the ranking according to interference power. More generally, an interference sector is considered as a significant interferer based on its interference power. In one embodiment, the mobile device also determines the total interference power due to all the significant interferers from the preamble symbols 212 and 213 of the received signal. See FIG. 2. As used herein, ‘interferers’ refer to signals from interfering sectors. At step 504, the mobile device estimates a relative speed of the mobile device with respect to a base station of the serving cell (Doppler speed).

At step 506, the mobile device generates a first data symbol estimate by using data from a preamble symbol in the received signal. The mobile device uses a Preamble-Based Interference Cancellation Algorithm to generate a first data symbol estimate in this embodiment. At step 508, the mobile device generates a second data symbol estimate by using pilot information embedded in the data zone of the received signal. The mobile device uses a Pilot-Based Interference Cancellation Algorithm to generate the second data symbol estimate in this embodiment.

At step 510, the mobile device determines if the relative speed of the mobile device with respect to the base station of the serving cell (Doppler speed) exceeds a predetermined relative speed threshold. If the relative speed of the mobile device with respect to the base station of the serving cell (Doppler speed) exceeds a predetermined relative speed threshold, the mobile device proceeds to step 512. Otherwise the mobile device proceeds to step 514. At step 512, the mobile device determines if the ratio of total interference power and the noise power exceeds a predetermined power threshold. If a ratio of total interference power to the noise power exceeds the predetermined power threshold, the mobile device proceeds to step 516. Otherwise the mobile device proceeds to step 514. Although a single predetermined power threshold is presumed, different power thresholds can be used to determine when to proceed to step 514 and when to proceed to step 516. At step 514, the mobile device generates a third data symbol estimate by weighting the first data symbol estimate with unity. Thus, in this particular scenario, the second data symbol estimate is ignored and the third data symbol estimate is the same as the first data symbol estimate.

At step 516, the mobile device generates a third data symbol estimate by weighting the first data symbol estimate and the second data symbol estimate with a plurality of combining weights. In one embodiment, the plurality of combining weights are obtained from the error variance values calculated by executing a Preamble-Based Interference Cancellation Algorithm and a Pilot-Based Interference Cancellation Algorithm at the mobile device. For example, the third data symbol estimate S₃ can be defined as:

$${S}_{3} = {w}_{1} {S}_{1} + {w}_{2} {S}_{2} , wherein \\ {w}_{1} = \frac{{σ}_{2}^{2}}{{σ}_{1}^{2} + {σ}_{2}^{2}} \\ {w}_{2} = \frac{{σ}_{1}^{2}}{{σ}_{1}^{2} + {σ}_{2}^{2}} \qquad ( 8 )$$

Here, w₁ and w₂ are the plurality of combining weights, S₁ is the first data symbol estimate, S₂ is the second data symbol estimate, σ₁² is the mean squared error (MSE) of the first data symbol estimates after applying the Preamble-Based Interference Cancellation Algorithm (equation 6), and σ₂² is the MSE of the second data symbol estimates after applying the Pilot-Based Interference Cancellation Algorithm (equation 7 with suitable scaling). As shown in equations (8), the combining weights are in inverse proportion to the error variance of the first and second data symbol estimates. In one embodiment the mean squared error σ₁² of the first data symbol estimate and the mean squared error σ₂² of the second data symbol estimate are computed based on corresponding interference cancellation antenna weights.

In one embodiment, the third data symbol estimate generates a data symbol estimate of a Down Link Media Access Protocol (DL-MAP) control message. Consequently, the radio coverage region of the DL-MAP control messages can be substantially increased due to suppressed co-channel interference when this Hybrid Interference Cancellation algorithm is applied to estimate the DL-MAP control messages. Those skilled in the art will recognize and appreciate that the specifics of this example are merely illustrative of some embodiments and that the teachings set forth herein are equally applicable to any data/control message received by the mobile device.

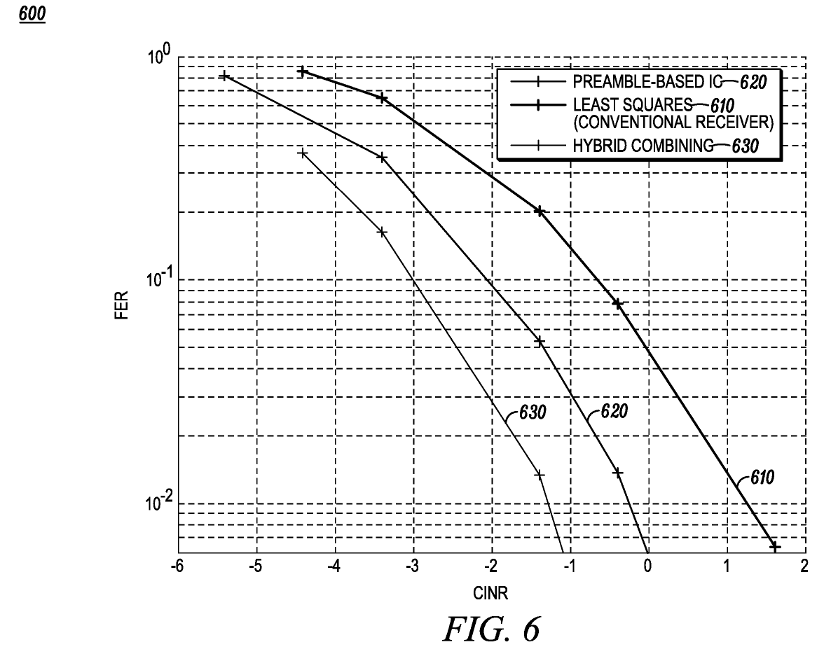

FIG. 6 illustrates simulation results 600 obtained from the implementation of various embodiments of the invention. The simulation results shown in FIG. 6 are obtained by implementing a Preamble-Based Interference Cancellation Algorithm as described here, a Pilot-Based Interference Cancellation Algorithm (least square conventional method), and a Hybrid Interference Cancellation Algorithm as described here—all at a mobile device having a Doppler speed of 30 kmph. For simulation purposes, mobile device has two receiver antennas and there is only one significant interferer. Also for purposes of the simulation, the ratio of the total interference power to noise is 10 dB. As shown in FIG. 6, the Preamble-Based Interference Cancellation Algorithm result 620 gives a gain of ˜1.5 dB over a conventional least square Interference Cancellation Algorithm result 610. Also, the Hybrid Interference Cancellation Algorithm result 630 outperforms the conventional method by 2.5 dB and the Preamble-Based Interference Cancellation Algorithm by 1 dB under these circumstances.

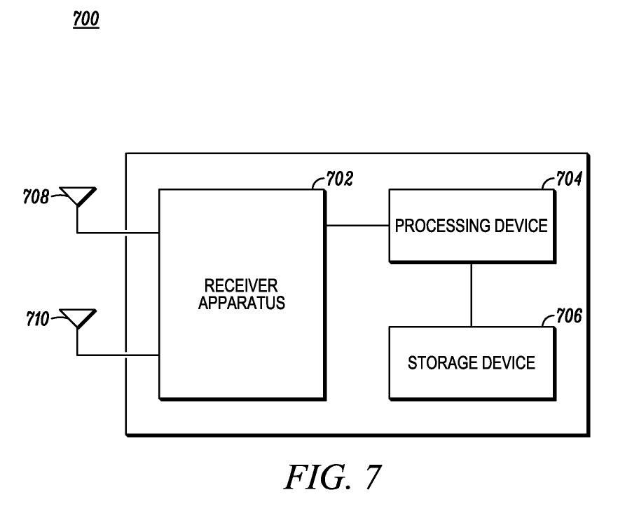

FIG. 7 is a block diagram illustrating portions of a mobile device 700 which is configured for cancelling interference in a sequence of received signals in accordance with various embodiments. The mobile device 700 includes a receiver apparatus 702. The receiver apparatus 702 is configured to receive a signal from a serving sector. Typically, the received signal is distorted by co-channel interference from neighboring sectors. In one embodiment, the receiver apparatus has at least two antennas (first antenna 708 and a second antenna 710). The receiver apparatus 702 further includes other hardware units (not shown) which are needed for performing the functionality of the receiver. The mobile device 700 further includes a processing device 704 and a storage device 706. As shown in FIG. 7, the processing device is coupled to the receiver apparatus 702. The processing device 704 can include microprocessors, digital signal processors, and one or more customized processors. The processing device 704 is configured to execute one or more Preamble-Based Interference Cancellation Algorithms, Pilot-Based Interference Cancellation Algorithms, and/or Hybrid Interference Cancellation Algorithms. In one embodiment, the processing device 704 performs the functions of: calculating a Channel State Information (CSI) of at least one interfering sector from a signal received at a first time interval; calculating a CSI of a serving sector corresponding to a second time interval; determining a correction factor to the CSI of the at least one interfering sector based on at least an elapsed time between the first time interval and the second time interval; and generating a symbol estimate for data symbols transmitted from the serving sector using the sequence of signals, the CSI of the serving sector, the CSI of the at least one interfering sector, and the correction factor.

The storage device 706 is coupled to the processing device 704. The storage device 706 can be used for storing any data values, threshold values, program codes, etc. For example, in one embodiment the storage device 706 stores look up tables from which an appropriate correction factor is selected in accordance to various embodiments of the invention. The mobile device 700 may further include other hardware units (not shown) such as a display, other user interface components, a battery, removable memory, etc.

By using various types of algorithms and either selecting or combining the resulting first data symbol estimate and second data symbol estimate, the results are generally accurate estimations of the actual data symbol transmitted by the base station of the serving cell. Because, the third data estimate is obtained by using information related to the actual state (particular scenario) of the mobile device, the third data estimate is a better (more accurate) estimate as compared to the first data estimate and the second data estimate. If the interfering cell is interfering through co-channel interference, more accurate data symbol estimates can allow for larger effective radio coverage regions associated with each sector. For example, the effective radio coverage region in an IEEE 802.16 based system can be substantially increased when embodiments of the invention are applied to estimate the data symbols in the control messages such as a DL-MAP in a system based on IEEE802.16. Also, accurate reception of data symbols helps to reduce the signaling overhead in signals transmitted from the base station of the serving cell. Furthermore, reduced signaling overhead helps to increase the effective throughput in the communication system.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. It should be recognized that the flow diagram, illustrated with include functionality that may be performed in hardware, firmware, software, or a combination thereof and may further be performed at a single hardware device or a combination of hardware devices at the mobile device. Also, one or more steps of the methods illustrated can be performed at supporting hardware units external to the mobile device.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for interference cancellation in a sequence of received signals at a mobile device, the method comprising:
calculating a Channel State Information (CSI) of at least one interfering sector from a signal received at a first time interval;
calculating a CSI of a serving sector corresponding to a second time interval;
determining a correction factor to the CSI of the at least one interfering sector based on at least an elapsed time between the first time interval and the second time interval; and
generating a symbol estimate for data symbols transmitted from the serving sector using the sequence of received signals, the CSI of the serving sector, the CSI of the at least one interfering sector, and the correction factor.

2. The method of claim 1, wherein the calculating a CSI of at least one interfering sector comprises:
processing a preamble signal in the sequence of received signals.

3. The method of claim 1, wherein the calculating a CSI of a serving sector comprises:
processing a plurality of pilots corresponding to the serving sector in the sequence of received signals.

4. The method of claim 3, wherein the calculating a CSI of a serving sector comprises:
processing a preamble signal in the sequence of received signals.

5. The method of claim 1, wherein the determining comprises:
using an estimated value of a relative speed of the mobile device with respect to a base station of the serving sector.

6. The method of claim 1, wherein the generating comprises:
computing interference cancellation antenna weights based on the CSI of the serving sector, the CSI of the at least one interfering sector, and the correction factor; and
applying the interference cancellation antenna weights to signals received on each antenna at the second time interval to obtain the symbol estimate.

7. The method of claim 6, wherein the computing comprises:
calculating a channel covariance matrix at the first time interval of the at least one interfering sector based on the CSI of the at least one interfering sector;
calculating a weighted channel covariance matrix weighted by the correction factor; and
determining the interference cancellation antenna weights based on the weighted channel covariance matrix and the CSI of the serving sector.

8. The method of claim 6, wherein the computing comprises:
calculating a channel covariance matrix at the second time interval of the at least one interfering sector based on the CSI of the at least one interfering sector; and
determining the interference cancellation antenna weights based on the channel covariance matrix and the CSI of the serving sector.

9. A method for interference cancellation in a sequence of received signals at a mobile device, the method comprising:
determining a Channel State Information (CSI) of at least one interfering sector;
generating a first data symbol estimate using a signal that is received by the mobile device during a time interval;
generating a second data symbol estimate using the signal received during the time interval;
calculating a plurality of combining weights;
generating a third data symbol estimate by using the first data symbol estimate, the second data symbol estimate, and the plurality of combining weights.

10. The method of claim 9, wherein the generating a first data symbol estimate comprises:
using the CSI of at least one interfering sector from a preamble signal in the sequence of received signals.

11. The method of claim 9, wherein the generating a second data symbol estimate comprises:
using a plurality of serving sector pilots in the sequence of received signals.

12. The method of claim 9, wherein the calculating comprises:
determining a number of significant interferers from a preamble signal in the signal based on power present in a channel of any interfering sector;
computing a total interference power of the number of significant interferers; and
establishing the plurality of combining weights based on the total interference power.

13. The method of claim 12, wherein the calculating further comprises:
estimating a relative speed of the mobile device with respect to a base station of a serving sector; and
using the relative speed to establish the plurality of combining weights.

14. The method of claim 9, wherein the generating a third data symbol estimate comprises:
weighting the first data symbol estimate and the second data symbol estimate with the plurality of combining weights if a relative speed of the mobile device with respect to a base station of a serving sector exceeds a predetermined relative speed threshold and if a ratio of a total interference power to a noise power is more than a predetermined power threshold.

15. The method of claim 14, wherein the generating a third data symbol estimate further comprises:
weighting the first data symbol estimate with unity if the relative speed of the mobile device with respect to the base station of a serving sector is less than the predetermined relative speed threshold.

16. The method of claim 14, wherein the generating a third data symbol estimate further comprises:
weighting the first data symbol estimate with unity if the ratio is less than the predetermined power threshold.

17. The method of claim 9, wherein the third data symbol estimate S₃ is defined as:
$${S}_{3} = {w}_{1} {S}_{1} + {w}_{2} {S}_{2} , wherein$$
$${w}_{1} = \frac{{σ}_{2}^{2}}{{σ}_{1}^{2} + {σ}_{2}^{2}}$$
$${w}_{2} = \frac{{σ}_{1}^{2}}{{σ}_{1}^{2} + {σ}_{2}^{2}}$$
and where w₁ and w₂ are the plurality of combining weights, S₁ is the first data symbol estimate, S₂ is the second data symbol estimate, σ₁² is a mean squared error of the first data symbol estimate, and σ₂² is a mean squared error of the second data symbol estimate.

18. The method of claim 17, wherein the mean squared error σ₁² of the first data symbol estimate and the mean squared error σ₂² of the second data symbol estimate are computed based on corresponding interference cancellation antenna weights.

19. The method of claim 9, wherein generating the third data symbol estimate generates a data symbol estimate of a Down Link Media Access Protocol (DL-MAP) control message.

20. An apparatus for interference cancellation in a received signal comprising:
a receiver apparatus for receiving a sequence of signals distorted by co-channel interference;
a processing device coupled to the receiver apparatus, the processing device configured to perform functions of:
calculating a Channel State Information (CSI) of at least one interfering sector from a signal received at a first time interval;
calculating a CSI of a serving sector corresponding to a second time interval;
determining a correction factor to the CSI of the at least one interfering sector based on at least an elapsed time between the first time interval and the second time interval; and
generating a symbol estimate for data symbols transmitted from the serving sector using the sequence of signals, the CSI of the serving sector, the CSI of the at least one interfering sector, and the correction factor.

21. The apparatus of claim 20, wherein the receiver apparatus comprises:
at least two antennas.

22. The apparatus of claim 20 further comprising:
a storage device coupled to the processing device for storing threshold values and look-up table for the correction factor.
